(19) United States
(12) Patent Application Publication
(10) Pub. No.: US 2017/0300582 A1
(43) Pub. Date: Oct. 19, 2017

(54) EVENT IDENTIFICATION THROUGH ANALYSIS OF SOCIAL-MEDIA POSTINGS

(71) Applicants: Gary KING, Brookline, MA (US); Jennifer PAN, Boston, MA (US); Margaret E. ROBERTS, Cambridge, MA (US)

(72) Inventors: Gary KING, Brookline, MA (US); Jennifer PAN, Boston, MA (US); Margaret E. ROBERTS, Cambridge, MA (US)

(21) Appl. No.: 15/516,977

(22) PCT Filed: Oct. 5, 2015
(86) PCT No.: PCT/US15/53959

§ 371 Date: Apr. 5, 2017

Related U.S. Application Data
(60) Provisional application No. 62/060,244, filed on Oct. 6, 2014.

(51) Int. Cl. G06F 17/30

(52) U.S. Cl. CPC G06F 17/30867; G06F 17/30011

(57) ABSTRACT

In various embodiments, documents such as social-media postings are analyzed to identify volume bursts, and the bursts are analyzed to compute probability metrics associated with events or types of events.

### RELATED APPLICATION

This application claims the benefit of and priority to U.S. Provisional Patent Application No. 62/060,244, filed Oct. 6, 2014, the entire disclosure of which is hereby incorporated herein by reference.

### TECHNICAL FIELD

In various embodiments, the present invention relates to event identification, in particular to computer-assisted document analysis and associated volume-burst detection for event identification.

### BACKGROUND

Despite the widespread and proliferating availability of information, it can be difficult to ascertain or measure the occurrence of certain real-world events. In some cases, media coverage of activities perceived as threatening is suppressed by a government. In other cases, such as the spread of a disease, individual cases do not rise to the level of reportable news even though, collectively, the pace and location of disease occurrence can have vital importance for controlling the outbreak.

Social media platforms, such as TWITTER or WEIBO, host spontaneous expressions by individuals that are publicly accessible, difficult to censor (at least efficiently or perfectly), and frequently refer to contemporaneous occurrences. The ease of posting allows individuals to, in effect, act as reporters of events too local or personal for professional media, or from which such media may be excluded by governmental policy. Public availability of these postings and their amenability to automated analysis facilitates the detection of events that might otherwise remain hidden or diffuse. To date, however, the availability of technologies for exploiting this potential has been minimal.

In view of the foregoing, there is a need for systems and methods for analyzing documents, such as social-media postings, to identify occurrences of various types of events in the world even outside of social media, and even when censorship policies meant to obscure such occurrences are deployed.

### SUMMARY

Various embodiments of the present invention pertain to techniques for analyzing a collection of electronically stored documents, such as social-media postings, to measure occurrences of a type of event based on contents of the documents. An exemplary application involves the prevalence, location, and substantive content of collective action events, which are protests, rallies, and any other movement or collection of people controlled by anyone other than the government—and particularly in countries, such as China, with active censorship policies. Social media in China is large, pervasive, and growing fast, but it is all subject to the huge and well-developed Chinese censorship apparatus. It has been found that China does not censor criticism of the government, its policies, and its leaders, no matter how vitriolic, personal, or incendiary. Instead, the vast majority of social media censorship in China concerns real-world events with collective-action potential.

In particular, it is found that Chinese censors look for volume bursts of social media activity (such as when ideas go viral over a few hours or days), ascertain the real-world event that is the subject of discussion in these bursts, and then remove all posts in any burst about an event with collective-action potential (regardless of whether the posts support or oppose the government). The censors care less about the substantive content of a message than its potential for stimulating and/or spreading collective action.

In accordance with embodiments of the present invention, the inferential task is reversed, and social media volume bursts with high rates of censorship are detected and assessed as indicators of collective action on the ground. (As used herein, the term “censorship” refers to government activity affecting document contents, which may range from outright deletion of a document to alteration or removal of some of the contents.) Given the strength of these patterns, finding the censored volume bursts will reliably identify collective action events. (Although government censors also target volume bursts when they contain criticism of, for example, the censors or pornography, these types of content are readily filtered.) For this exemplary application, embodiments of the present invention make it possible to amass a large enough sample of collective-action events to produce informative classifications of event types; to identify the most prevalent geographic regions and times of the year for these events; to study the issues, communities, and governments to which these actions are most frequently directed; to predict when they are most likely to occur; and to see, and potentially predict, what action the government takes in response, and how, in turn, the people respond to that government action.

In an aspect, embodiments of the invention feature a system for receiving, electronically posting, and analyzing documents to measure occurrences of a type of event based on contents of the documents. The system includes or consists essentially of a social media server for receiving, via a computer network, postings from a community of users and making the postings electronically accessible, via the computer network, to the community of users, a memory for storing the documents, a computer processor, and a document-analysis module. The document-analysis module is executable by or responsive to the computer processor for (i) computationally analyzing the postings and identifying volume bursts of postings, the volume bursts corresponding to a rate of document posting over a defined period of time exceeding an average rate of document posting by a thresholding factor, (ii) computationally analyzing the bursts for contents corresponding to the type of event and/or to detect changes in burst size as a function of time, and (iii) based on the burst analysis, computing a probability metric associated with the event type.

Embodiments of the invention may include one or more of the following in any of a variety of combinations. The document-analysis module may be further configured to statistically assign each of the postings to one of a plurality of clusters based on a time of posting and contents of the posting. The volume bursts may be detected within each of the clusters and may correspond to a rate of posting within the cluster over a defined period of time exceeding, by a thresholding factor, an average rate of posting within the cluster. The document-analysis module may be further configured to (i) computationally apply a discrete keyword-based classifier to the postings to identify postings with contents corresponding to the event, and (ii) cluster the identified postings by at least one of time of creation, contents, author, geography, or an amount of external alteration. The volume bursts may be detected within each of the clusters and may correspond to a rate of posting within the cluster over a defined period of time exceeding, by a thresholding factor, an average rate of posting within the cluster. The document-analysis module may be further configured to align the clusters across time. The system may include a signaling module. The signaling module may be executable by or responsive to the computer processor for signaling an alert if the probability metric exceeds a signaling threshold. The signaling module may be configured to signal the alert by sounding an audible alarm, electronically sending or displaying a message, and/or electronically identifying one or more documents associated with the event.

In another aspect, embodiments of the invention feature a method of analyzing a collection of electronically stored documents to measure occurrences of a type of event based on contents of the documents. A discrete keyword-based classifier is computationally applied to the documents to identify documents with contents corresponding to an event. The identified documents are clustered by time of creation, contents, author, geography, and/or an amount of external alteration. The clusters are aligned across time. Any volume bursts of documents are detected within each of the clusters, the volume bursts corresponding to a rate of document creation over a defined period of time exceeding an average rate of document creation by a thresholding factor. The bursts are computationally analyzed to detect changes in a size of each burst as a function of time. Based on the burst analysis, a probability metric associated with the event type is computed.

Embodiments of the invention may include one or more of the following in any of a variety of combinations. An external effect on documents in any of the volume bursts may be detected. The probability metric may be updated in accordance with the event type and/or based on the external effect. The external effect may be censorship of the documents. The event may be collective action. Detection of censorship may increase a value of the probability metric. An alert may be signaled if the probability metric exceeds a signaling threshold. Signaling the alert may include, consist essentially of, or consist of sounding an audible alarm, electronically sending or displaying a message, and/or electronically identifying one or more documents associated with the event.

In yet another aspect, embodiments of the invention feature a method of analyzing a collection of electronically stored documents to measure occurrences of a type of event based on contents of the documents. In a step (a), contents of the documents are analyzed and, based on the contents analysis, the documents are partitioned into a plurality of categories each corresponding to a topic. In a step (b), any volume bursts of documents within each of the categories are detected, the volume bursts corresponding to a rate of document creation over a defined period of time exceeding an average rate of document creation by a thresholding factor. In a step (c), in categories in which bursts were not detected, the documents are computationally repartitioned into a plurality of different categories each corresponding to a topic. In a step (d), any volume bursts of documents within each of the different categories are detected, the volume bursts corresponding to a rate of document creation over a defined period of time exceeding an average rate of document creation by a thresholding factor. In a step (e), the detected volume bursts are computationally analyzed for content relevance to the event type and/or to detect changes in a size of each burst as a function of time. In a step (f), a probability metric associated with the event type is computed based on the burst analysis.

Embodiments of the invention may include one or more of the following in any of a variety of combinations. Steps (c)-(e) may be repeated at least once, and the probability metric may be updated based thereon. An external effect on documents in any of the volume bursts may be detected. The probability metric may be updated in accordance with the event type and/or based on the external effect. The external effect may be censorship of the documents. The event may be collective action. Detection of censorship may increase a value of the probability metric. An alert may be signaled if the probability metric exceeds a signaling threshold. Signaling the alert may include, consist essentially of, or consist of sounding an audible alarm, electronically sending or displaying a message, and/or electronically identifying one or more documents associated with the event.

In another aspect, embodiments of the invention feature a method of analyzing a collection of electronically stored documents to measure occurrences of a type of event based on contents of the documents. The documents are statistically assigned to one of a plurality of clusters based on a time of document creation and document contents. Any volume bursts of documents are detected within each of the clusters, the volume bursts corresponding to a rate of document creation over a defined period of time exceeding an average rate of document creation by a thresholding factor. The bursts are computationally analyzed for content relevance to the event type and/or to detect changes in a size of each burst as a function of time. A probability metric associated with the event type is computed based on the burst analysis.

Embodiments of the invention may include one or more of the following in any of a variety of combinations. An external effect on documents in any of the volume bursts may be detected. The probability metric may be updated in accordance with the event type and/or based on the external effect. The external effect may be censorship of the documents. The event may be collective action. Detection of censorship may increase a value of the probability metric. An alert may be signaled if the probability metric exceeds a signaling threshold. Signaling the alert may include, consist essentially of, or consist of sounding an audible alarm, electronically sending or displaying a message, and/or electronically identifying one or more documents associated with the event.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and may exist in various combinations and permutations. As used herein, a “keyword” is all or a portion of a Boolean search string, i.e., one or more words used as reference points for finding other words or information, and/or that indicate content and/or relevance of a document, which may be linked by one or more Boolean operators (e.g., AND or NOT, which may thus be parts of “keywords” as used herein). As used herein, the terms “approximately” and “substantially” mean±10%, and in some embodiments, ±5%. The term “consists essentially of” means excluding other materials that contribute to function, unless otherwise defined herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a block diagram of a system for document analysis in accordance with various embodiments of the present invention;

FIG. 2 is a flowchart of a method for document analysis in accordance with various embodiments of the present invention;

FIG. 3 is a flowchart of a method for document analysis in accordance with various embodiments of the present invention; and

FIG. 4 is a flowchart of a method for document analysis in accordance with various embodiments of the present invention.

### DETAILED DESCRIPTION

Various embodiments of the present invention feature techniques for analyzing a collection of electronically stored documents, such as social-media postings, to measure occurrences of a type of event based on contents of the documents. Embodiments of the invention may be utilized to identify and categorize collective action events, even in the face of active government censorship policies. Specifically, volume bursts of documents with high rates of censorship may be detected and utilized to detect and predict collective action.

In accordance with various embodiments of the invention, known techniques (see, e.g., King et al., “How Censorship in China Allows Government Criticism but Silences Collective Expression,” American Political Science Review 107, no. 2 (May 2013): 1-18, and King et al., “Reverse-Engineering Censorship in China: Randomized Experimentation and Participant Observation.” Science 345 (6199): 1-10 (2014), the entire disclosure of each of which is incorporated by reference herein), are utilized to obtain social-media posts from a particular geographic area or political entity or community (e.g., a country such as China, a state, a county, a city, etc.) before the censors can read and remove from the web (i.e., censor) those (or portions thereof) they deem objectionable. Each social-media post may be computationally revisited in the minutes or hours after posting to see whether and when it is censored.

One way of detecting volume bursts in accordance with embodiments of the invention is by partitioning all documents (e.g., social-media posts) into selected topic areas, plotting the volume of posts over time within each, and then using automation to identify bursts given any well-defined topic area. Various embodiments of the invention utilize a different approach, however. In such embodiments, the documents are iteratively partitioned into a set of topic categories, and then bursts are detected within the categories. Documents are re-partitioned in categories where bursts were not well detected, and the partitioned documents are re-examined for bursts. This iterative approach locates the maximum number of volume bursts in the data.

An alternative is to cluster the documents by time and by content and detect bursts within those clusters. Techniques for statistical clustering are well known (see, e.g., Roberts et al., “Structural Topic Models for Open-Ended Survey Responses,” American Journal of Political Science, Vol. 58, No. 4, pp. 1064-1082 (2014), hereafter “Roberts 2014,” the entire disclosure of which is incorporated by reference herein). Still another alternative in accordance with embodiments of the invention includes three steps. First, a discrete keyword-based classifier (see, e.g., King et al., “Reverse-engineering Censorship in China: Randomized Experimentation and Participant Observation,” Science 345, no. 6199: 1-10 (2014), as well as International Patent Application Serial No. PCT/US2014/046524, filed on Jul. 14, 2014, the entire disclosure of each of which is incorporated by reference herein) is utilized to identify documents (e.g., social-media posts) that discuss some type of collective action. To construct a keyword-based classifier, embodiments of the invention may utilize techniques described in Chidanand Apte, Fred Damerau, and Sholom M. Weiss, “Automated Learning of Decision Rules for Text Categorization,” ACM Transactions on Information Systems, 12(3):233-251 (1993); William W. Cohen, “Learning Rules that Classify E-Mail,” in AAAI Spring Symposium on Machine Learning in Information Access (1996); and William W. Cohen and Yoram Singer, “Context-Sensitive Learning Methods for Text Categorization,” ACM Transactions on Information Systems 17(2):141-173 (1999), the entire disclosure of each of which is incorporated by reference herein. Various embodiments of the invention utilize techniques similar to those described in Benjamin Letham, Cynthia Rudin, Tyler H McCormick, and David Madigan, “Interpretable Classifiers Using Rules and Bayesian Analysis: Building a Better Stroke Prediction Model,” (2013), based on Bayesian List Machines (BLM), the entire disclosure of which is incorporated by reference herein.

The classified documents may be analyzed (e.g., clustered) to find similar documents nearby in time, content, author, geography, and/or percent censored. Based on these features, documents may be clustered into topics or events, taking place at a particular time, using automated clustering algorithms such as those described in Roberts 2014. Clusters may be aligned across time based on these features. The “birth” or “death” of events may be detected as occurring between days and significant changes in the volume of a cluster across days. Finally, each cluster may be analyzed to determine whether it constitutes a burst; for example, the cluster may be thresholded in terms of absolute size and/or size relative to temporally proximate clusters. That is, a statistically significant deviation may suggest a burst, with the degree of deviation providing a confidence level.

Once volume bursts have been identified as detailed above, further processing may extract 1) the details of the event and 2) the characteristics of the document authors (e.g., social-media users) who themselves are reporting on and discussing the event. Well-known methods of named-entity recognition, for example, may be applied to posts associated with each burst to identify actors, organizations, and places involved in the events. For example, one such named-entity recognition method uses a statistical algorithm based on a conditional random field sequence model that identifies proper nouns within the text; see Sutton and McCallum, “An introduction to conditional random fields for relational learning,” in Introduction to statistical relational learning, pp. 93-128, MIT Press (2006), and J. Lafferty, et al., “Conditional Random Fields: Probabilistic Models for Segmenting and Labeling Sequence Data,” Proceedings of the 18th International Conference on Machine Learning 2001 (ICML 2001), Morgan Kaufmann Publishers Inc. San Francisco, Calif., pp. 282-289 (2001) (the entire disclosure of each of which is incorporated by reference herein). Next, the actions of the individuals and organizations within each burst may be identified. Using “part of speech tagging,” for example, permits identification of major “action” phrases, or “event tuples” within the documents to determine, in the exemplary case of an event corresponding to a protest, the grievances of the protesters, the actions the protesters were taking, and the actions the government was taking in response to the protest.

When available, geographic information associated with the documents may be used to identify the locations of the authors who are reporting on the activity of interest. Locational information may also help uncover the extent to which information about the protest or rally has spread. Geographic information is typically available in metadata that accompanies documents such as social-media posts, the biography of the author available at the social media site, and in the raw text of the large volume of social-media posts in the identified volume burst. Social-media posts may have other types of explicit metadata and implicit signals from the biography and raw text in addition to the geographical information about them. This often includes the gender, age, content of previous posts, or occupation of the author. This metadata, along with the followership patterns in the data, may be used to describe the types of people who seem to be following or reporting on the event, painting a picture of the types of circles and networks through which the information is being circulated. Finally, when available, metadata about the linkages among authors and other users, including followers, retweets, and those followed, may be analyzed to better understand the propensity for the information about the event (e.g., a collective action event) to spread through the network—e.g., whether information about an event is being broadcast by a central node, and rapidly retweeted (indicating viral spread); or whether information about an event is originating from one account of the event or from multiple sources.

To characterize the content of collective action events, the content of volume bursts for any given time period may be analyzed by, for example, identifying words or phrases that are frequently contained in each burst, and which predict being in the burst as opposed to outside it, to represent the burst. This representation, in turn, is searchable or viewable, enabling users to peruse probable censorship events during the time period and then directly examine the social-media description of these events. This automated summary may be supplemented with additional external information from newspaper reports when available, open video feeds, telephone interviews, etc.

With enough examples of events generated by embodiments of the invention described herein, it is possible to distinguish types of these events, such as (i) events likely to provoke only the censors to action, (ii) events also likely to generate police action, and (iii) events likely to provoke even more violent reprisals. By providing a measure of virality, embodiments of the invention indicate the degree to which collective action in one area may spread from event to event or community to community.

Since “burstiness” is a generic feature of social-media data in all countries, embodiments of the present invention may be used to study health events, pollution events, or corruption events, topics often discussed on social media but where data is not readily available. In the area of health, detecting events by locality enables the identification of trends both in the spread of diseases as well as responses to disease. While pollution-related collective action is increasingly common in China, embodiments of the invention may identify pollution events that have not yet escalated to the level of collective protest—for example, spikes in air pollution levels by locality and time as well as changing environmental practices by firms. Embodiments of the invention are also useful in countries or other locations where data is scarce, but reports of happenings on social media are common—e.g., in Iran.

Various embodiments of the invention are implemented on a computing device that includes a processor and utilizes various program modules. Program modules may include or consist essentially of computer-executable instructions that are executed by a conventional computer. Generally, program modules include routines, programs, objects, components, data structures, etc. that performs particular tasks or implement particular abstract data types. As used herein, a “computer network” is any wired and/or wireless configuration of intercommunicating computational nodes, including, without limitation, computers, switches, routers, personal wireless devices, etc., and including local area networks, wide area networks, and telecommunication and public telephone networks.

Those skilled in the art will appreciate that embodiments of the invention may be practiced with various computer system configurations, including multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote computer-storage media including memory storage devices.

Thus, systems in accordance with embodiments of the present invention may include or consist essentially of a general-purpose computing device in the form of a computer including a processing unit (or “processor” or “computer processor”), a system memory, and a system bus that couples various system components including the system memory to the processing unit. Computers typically include a variety of computer-readable media that can form part of the system memory and be read by the processing unit. By way of example, and not limitation, computer readable media may include computer storage media and/or communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

Any suitable programming language may be used to implement without undue experimentation the functions described above. Illustratively, the programming language used may include assembly language, Ada, APL, Basic, C, C++, C*, COBOL, dBase, Forth, FORTRAN, Java, Modula-2, Pascal, Prolog, Python, REXX, and/or JavaScript for example. Further, it is not necessary that a single type of instruction or programming language be utilized in conjunction with the operation of systems and techniques of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general-purpose processor, but may utilize any of a wide variety of other technologies including special-purpose hardware, a microcomputer, mini-computer, mainframe computer, programmed micro-processor, micro-controller, peripheral integrated circuit element, a CSIC (customer-specific integrated circuit), ASIC (application-specific integrated circuit), a logic circuit, a digital signal processor, a programmable logic device such as an FPGA (field-programmable gate array), PLD (programmable logic device), PLA (programmable logic array), RFID processor, smart chip, or any other device or arrangement of devices that is capable of implementing the steps of the processes of embodiments of the invention.

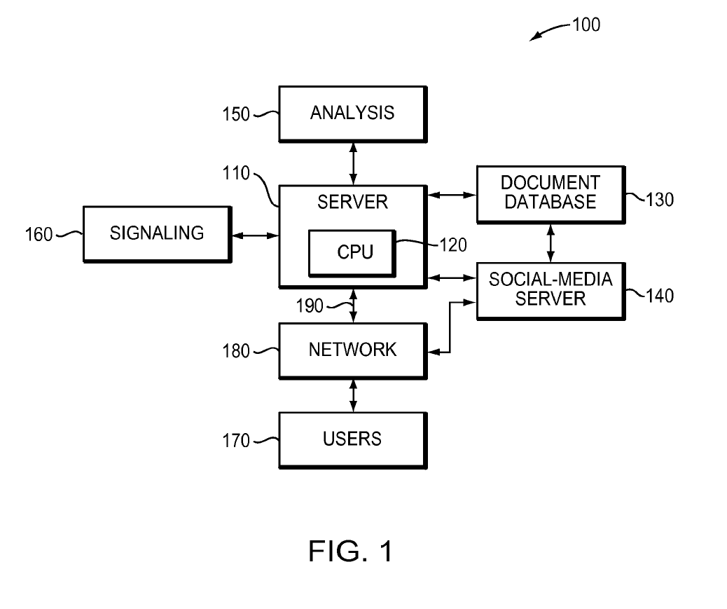

Thus, as depicted in FIG. 1, a document analysis system 100 in accordance with various embodiments of the invention features an analysis server 110 (that includes a computer processor 120), a document database 130, a social-media server 140, an analysis module 150, and a signaling module 160. The document database 130 may include or consist essentially of a memory that electronically stores documents, e.g., social-media postings. The document database 130 may also electronically store lists or collections of event types and/or probability metrics computed during analysis of the documents. As utilized herein, the term “electronic storage” broadly connotes any form of digital storage, e.g., optical storage, magnetic storage, semiconductor storage, etc. Furthermore, a document may be “stored” via storage of the document itself, a copy of the document, a pointer to the document, or an identifier associated with the document, etc.

The social media server 140, as known in the art, receives postings (e.g., documents that may include or consist essentially of text, images, video, etc.) from a community of users 170, via a computer network (e.g., computer network 180), and makes the postings electronically accessible to the community of users via the computer network. Social media server 140 may include or consist essentially of, e.g., a server for postings on a social media website such as FACEBOOK, WEIBO, or TWITTER. The documents may be stored in the document database 130 and analyzed by analysis server 110 (via analysis module 150 executable by processor 120). In various embodiments of the invention, the analysis server 110 and the social media server 140 may be combined on a single machine or distributed among two or more discrete or linked pieces of computer hardware. For example, the social-media server functionality may be hosted along with the analysis functionality described herein or may instead be remote and accessed, via the Internet (or other computer network) by the analysis server; in either case, it is considered part of various system embodiments hereof. The document database 130 may be hosted within (i.e., a portion of) social-media server 140 (or analysis server 110), or it may be discrete therefrom.

The analysis module 150 and the signaling module 160 may be implemented by computer-executable instructions, such as program modules, that are executed by a conventional computer (e.g., analysis server 110). Generally, program modules include routines, programs, objects, components, data structures, etc. that perform particular tasks or implement particular abstract data types. Those skilled in the art will appreciate that embodiments of the invention may be practiced with various computer system configurations, including multiprocessor systems, microprocessor-based or programmable consumer electronics, minicomputers, mainframe computers, and the like. As noted above, embodiments of the invention may also be practiced in distributed computing environments where tasks are performed by remote processing devices that are linked through a communications network. In a distributed computing environment, program modules may be located in both local and remote computer-storage media including memory storage devices.

The analysis module 150 performs a variety of analytical functions in accordance with embodiments of the present invention. For example, the analysis module 150 may computationally analyze documents (e.g., social media postings) and identify volume bursts thereof, where volume bursts correspond to a rate of document posting or creation over a defined period of time that exceeds an average rate of document posting or creation by a thresholding factor (e.g., a factor of 1.5 or more, a factor of 2 or more, or even a factor of 10 or 100 or more). The analysis module 150 may also analyze the identified volume bursts for contents corresponding to one or more types of event (e.g., a protest, a rally, or other collective action event) and, based on this burst analysis, compute a probability metric associated with the type of event. As used herein, the term “probability metric” refers to any quantitative measure of the probability that an event is occurring contemporaneously with one or more of the documents or will occur at a later time. For example, the probability metric may be a statistical measure of certainty such as a confidence interval in the range of 0% to 100%. The probability metric may be based on, e.g., the number and/or percentage of documents within a particular burst having contents relevant (e.g., referencing) the event or event type, and can be associated with a likelihood of the event or event type based on standard statistical procedures—e.g., assuming that the burst level and occurrence of the event are random variables and measuring the statistical distance between the threshold burst level and actual event occurrence. The probability metric may also increase based on the total amount of time spanned by the burst, utilizing the assumption that an event is more likely to be taking place the longer it is being referenced. The analysis module 150 may also detect one or more external effects on the documents in the volume bursts and update the probability metric. For example, the document database 130 may be re-queried to determine if one or more of the analyzed documents (or portions thereof) have been censored, and the existence of such censorship may be utilized to increase the probability metric.

The signaling module 160 may be utilized to, for example, signal an alert in the event of the probability metric for a particular type of event exceeding an alert threshold. For example, if the probability metric computed by the system 100 exceeds, e.g., 50% probability of an event of that type occurring or likely to occur, the signaling module 160 may provide the alert. The form of the alert can vary with desired application and can involve sounding an audible alarm, issuing a notification by sending a message (e.g., an electronic message), electronically identifying one or more documents associated with the event, displaying the event and/or the likelihood of its occurrence on a display, etc. As utilized herein, “electronically identifying” documents may include or consist essentially of displaying all or a portion of each document, a list of the documents (by, e.g., title or abstract), etc. The signaling module 160 may even signal an alert if an external effect (e.g., censorship) on one or more documents in document database 130 is detected. The signaling module 160 may include or consist essentially of software, hardware (e.g., one or more output devices such as a display, printer, speaker, etc.), or a combination thereof.

The system 100 also may include a communications interface 190 for accepting, from one or more users 170, user input such as search queries and analysis requests, and/or for signaling alerts from the signaling module 160. The communications interface 180 may include or consist essentially of, e.g., one or more input devices such as a keyboard, mouse or other pointing device, or microphone (for spoken input) and/or one or more output devices such as a display, printer, speaker, etc. The communications interface 180 may communicate with the server 110 (e.g., with the computer processor 120) and/or various modules locally or over the computer network 180 (e.g., the Internet or a local network such as a local area network (LAN) or wide area network (WAN)).

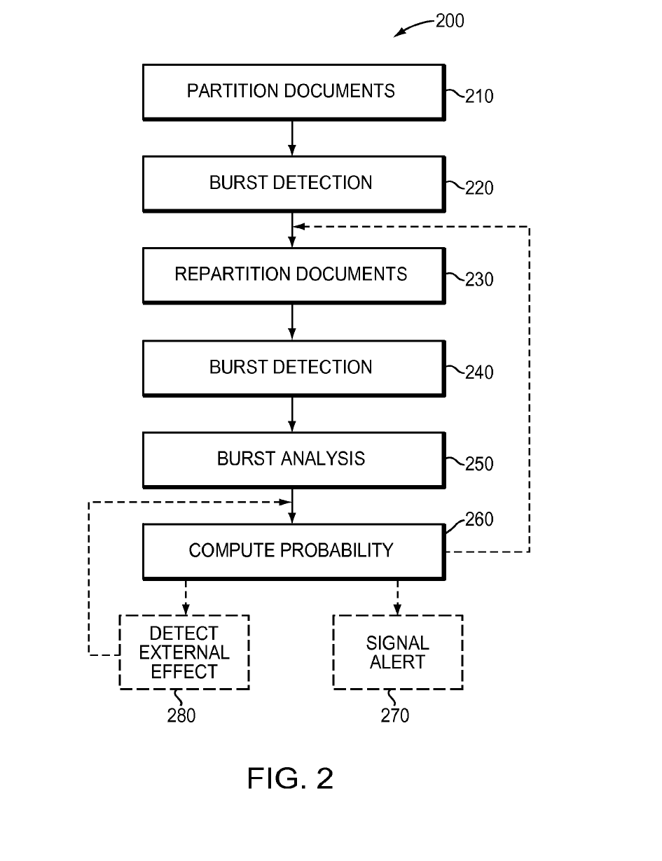

FIG. 2 depicts an exemplary method 200 of document analysis in accordance with various embodiments of the present invention. As shown, in accordance with various embodiments, in step 210 of method 200, contents of all or a subset of the documents in document database 130 are analyzed by analysis module 150, and the documents are partitioned into various categories that each correspond to a particular topic. In step 220, the documents in each of the categories are analyzed by analysis module 150 to detect any volume bursts. For example, the documents are analyzed to identify localized rates of document creation over periods of time that exceed an average rate of document creation for all of the documents in the category (e.g., by a particular thresholding factor). (As used herein, a rate of document creation corresponds to the number of documents created over a particular time; thus, if a category contains 100 documents created over a time period of 100 hours, then the average rate of document creation is 1 document/hour. If 50 of those documents were created over a two-hour period within the 100 hours, then the 25 document/hour rate of document creation over those two hours will signify a volume burst for a thresholding factor of 25 or less.) In step 230, documents in the categories in which volume bursts were not detected are computationally repartitioned by analysis module 150 based on their contents. For example, one or more documents may be assigned to new categories based on, e.g., keywords within the documents not utilized for the initial categorization. In step 240, the burst analysis of step 220 may be repeated on the documents repartitioned in step 230. In step 250, the documents within each of the identified volume bursts may be analyzed, by the analysis module 150, for content relevant to one or more event types. In step 260, the output of the burst analysis of step 240 is utilized to compute a probability metric associated with the one or more event types. In an optional step 270, if the computed probability metric exceeds a signaling threshold, then the signaling module 160 may signal an alert. In an optional step 280, documents in document database 130 (or a subset thereof) are reanalyzed (e.g., after a period of time) in order to detect an external effect on the documents or their contents, e.g., censorship by a government or other entity having access to one or more of the documents. As shown, the probability metric may be updated based on the detected external effect. For example, if censorship is detected in step 280, then the probability metric may be increased.

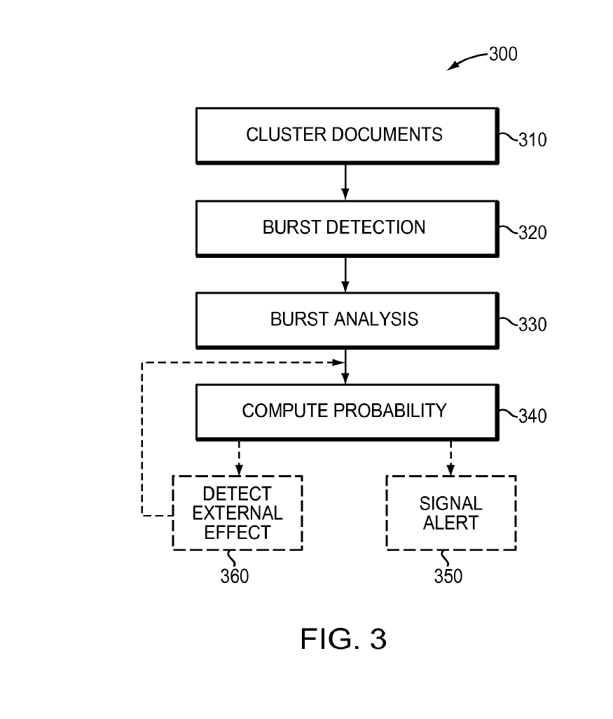

FIG. 3 depicts another exemplary method 300 of document analysis in accordance with various embodiments of the present invention. As shown, in accordance with various embodiments, in step 310 of method 300, contents of all or a subset of the documents in document database 130 are analyzed by analysis module 150, and the documents are clustered (i.e., statistically assigned to one of a group of different clusters) based on, e.g., the document creation (and/or edit) time (e.g., a posting time) and/or the contents of the documents. In step 320, the documents in each of the categories are analyzed by analysis module 150 to detect any volume bursts. For example, the documents are analyzed to identify localized rates of document creation over periods of time that exceed an average rate of document creation for all of the documents in the category (e.g., by a particular thresholding factor). In step 330, the documents within each of the identified volume bursts may be analyzed, by the analysis module 150, for content relevant to one or more event types. In step 340, the output of the burst analysis of step 330 is utilized to compute a probability metric associated with the one or more event types. In an optional step 350, if the computed probability metric exceeds a signaling threshold, then the signaling module 160 may signal an alert. In an optional step 360, documents in document database 130 (or a subset thereof) are reanalyzed (e.g., after a period of time) in order to detect an external effect on the documents or their contents, e.g., censorship by a government or other entity having access to one or more of the documents. As shown, the probability metric may be updated based on the detected external effect. For example, if censorship is detected in step 360, then the probability metric may be increased.

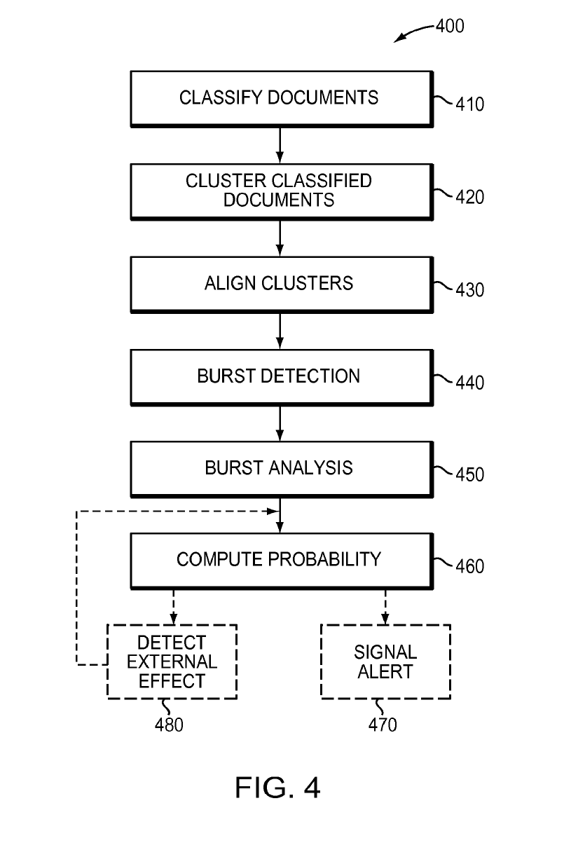

FIG. 4 depicts another exemplary method 400 of document analysis in accordance with various embodiments of the present invention. As shown, in accordance with various embodiments, in step 410 of method 400, a keyword-based classifier is applied to all or a subset of the documents in document database 130 by analysis module 150 to identify documents having contents corresponding to a particular event (or type of event). In step 420, the documents identified in step 410 are clustered (i.e., statistically assigned to one of a group of different clusters) based on, e.g., the document creation (and/or edit) time (e.g., a posting time), the contents of the documents, the author of the documents, the geography of the documents (i.e., the locality where the documents were created and/or any particular geographic region and/or landmark referenced in the documents), and/or if (or to what extent) the documents have been externally altered by a party other than the original author (e.g., amended or deleted by a censor). In step 430, the document clusters created in step 420 are aligned across time (i.e., ordered with respect to each other on the basis of a creation (or edit) time of one or more of the documents in the cluster). For example, clusters may be ordered on the basis of the earliest-created document in the cluster. When aligned, clusters (or portions thereof) may overlap with each other in time in the case of, e.g., events occurring contemporaneously. In step 440, the documents in each of the clusters are analyzed by analysis module 150 to detect any volume bursts. For example, the documents are analyzed to identify localized rates of document creation over periods of time that exceed an average rate of document creation for all of the documents in the category (e.g., by a particular thresholding factor). In step 450, the documents within each of the identified volume bursts may be analyzed, by the analysis module 150, to detect changes in the size of each burst as a function of time. For example, a large number of documents within the burst over a short period of time may indicate various happenings in conjunction with the event corresponding to the burst. The initial time of the burst (i.e., the creation time of the earliest document(s) in the burst may correspond to the initiation (or “birth”) of the event, and the creation time of the latest document(s) of the burst (or a sharp drop in the number of documents in the burst) may correspond to the end (or “death”) of the event. In step 460, the output of the burst analysis of step 450 is utilized to compute a probability metric associated with the one or more event types. In an optional step 470, if the computed probability metric exceeds a signaling threshold, then the signaling module 160 may signal an alert. In an optional step 480, documents in document database 130 (or a subset thereof) are reanalyzed (e.g., after a period of time) in order to detect an external effect on the documents or their contents, e.g., censorship by a government or other entity having access to one or more of the documents. As shown, the probability metric may be updated based on the detected external effect. For example, if censorship is detected in step 480, then the probability metric may be increased.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A system for receiving, electronically posting, and analyzing documents to measure occurrences of a type of event based on contents of the documents, the system comprising:
a social media server for receiving, via a computer network, postings from a community of users and making the postings electronically accessible, via the computer network, to the community of users;
a memory for storing the documents;
a computer processor; and
a document-analysis module executable by the computer processor for (i) computationally analyzing the postings and identifying volume bursts of postings, the volume bursts corresponding to a rate of document posting over a defined period of time exceeding an average rate of document posting by a thresholding factor, (ii) computationally analyzing the bursts for contents corresponding to the type of event and/or to detect changes in burst size as a function of time, and (iii) based on the burst analysis, computing a probability metric associated with the event type.

2. The system of claim 1, wherein the document-analysis module is further configured to statistically assign each of the postings to one of a plurality of clusters based on a time of posting and contents of the posting, the volume bursts being detected within each of the clusters and corresponding to a rate of posting within the cluster over a defined period of time exceeding, by a thresholding factor, an average rate of posting within the cluster.

3. The system of claim 1, wherein the document-analysis module is further configured to (i) computationally apply a discrete keyword-based classifier to the postings to identify postings with contents corresponding to the event, and (ii) cluster the identified postings by at least one of time of creation, contents, author, geography, or an amount of external alteration, the volume bursts being detected within each of the clusters and corresponding to a rate of posting within the cluster over a defined period of time exceeding, by a thresholding factor, an average rate of posting within the cluster.

4. The system of claim 1, wherein the document-analysis module is further configured to align the clusters across time.

5. The system of claim 1, further comprising a signaling module, executable by or responsive to the computer processor, for signaling an alert if the probability metric exceeds a signaling threshold.

6. The system of claim 5, wherein the signaling module is configured to signal the alert by at least one of sounding an audible alarm, electronically sending or displaying a message, or electronically identifying one or more documents associated with the event.

7. A method of analyzing a collection of electronically stored documents to measure occurrences of a type of event based on contents of the documents, the method comprising:
computationally applying a discrete keyword-based classifier to the documents to identify documents with contents corresponding to an event;
clustering the identified documents by at least one of time of creation, contents, author, geography, or an amount of external alteration;
aligning the clusters across time;
detecting any volume bursts of documents within each of the clusters, the volume bursts corresponding to a rate of document creation over a defined period of time exceeding an average rate of document creation by a thresholding factor;
computationally analyzing the bursts to detect changes in a size of each burst as a function of time; and
based on the burst analysis, computing a probability metric associated with the event type.

8. The method of claim 7, further comprising:
detecting an external effect on documents in any of the volume bursts; and
updating the probability metric in accordance with the event type.

9. The method of claim 8, wherein the external effect is censorship of the documents and the event is collective action, detection of censorship increasing a value of the probability metric.

10. The method of claim 7, further comprising signaling an alert if the probability metric exceeds a signaling threshold.

11. The method of claim 10, wherein signaling the alert comprises at least one of sounding an audible alarm, electronically sending or displaying a message, or electronically identifying one or more documents associated with the event.

12. A method of analyzing a collection of electronically stored documents to measure occurrences of a type of event based on contents of the documents, the method comprising:
(a) analyzing contents of the documents and, based on the contents analysis, partitioning the documents into a plurality of categories each corresponding to a topic;
(b) detecting any volume bursts of documents within each of the categories, the volume bursts corresponding to a rate of document creation over a defined period of time exceeding an average rate of document creation by a thresholding factor;
(c) in categories in which bursts were not detected, computationally repartitioning the documents into a plurality of different categories each corresponding to a topic;
(d) detecting any volume bursts of documents within each of the different categories, the volume bursts corresponding to a rate of document creation over a defined period of time exceeding an average rate of document creation by a thresholding factor;
(e) computationally analyzing the detected volume bursts for content relevance to the event type; and
(f) based on the burst analysis, computing a probability metric associated with the event type.

13. The method of claim 12, further comprising:
repeating steps (c)-(e) at least once; and
updating the probability metric based thereon.

14. The method of claim 12, further comprising:
detecting an external effect on documents in any of the volume bursts; and
updating the probability metric in accordance with the event type.

15. The method of claim 14, wherein the external effect is censorship of the documents and the event is collective action, detection of censorship increasing a value of the probability metric.

16. The method of claim 12, further comprising signaling an alert if the probability metric exceeds a signaling threshold.

17. The method of claim 16, wherein signaling the alert comprises at least one of sounding an audible alarm, electronically sending or displaying a message, or electronically identifying one or more documents associated with the event.

18. A method of analyzing a collection of electronically stored documents to measure occurrences of a type of event based on contents of the documents, the method comprising:
statistically assigning the documents to one of a plurality of clusters based on a time of document creation and document contents;
detecting any volume bursts of documents within each of the clusters, the volume bursts corresponding to a rate of document creation over a defined period of time exceeding an average rate of document creation by a thresholding factor;
computationally analyzing the bursts for content relevance to the event type; and
based on the burst analysis, computing a probability metric associated with the event type.

19. The method of claim 18, further comprising:
detecting an external effect on documents in any of the volume bursts; and
updating the probability metric in accordance with the event type.

20. The method of claim 19, wherein the external effect is censorship of the documents and the event is collective action, detection of censorship increasing a value of the probability metric.

21. The method of claim 18, further comprising signaling an alert if the probability metric exceeds a signaling threshold.

22. The method of claim 21, wherein signaling the alert comprises at least one of sounding an audible alarm, electronically sending or displaying a message, or electronically identifying one or more documents associated with the event.
